(19) United States
(12) Patent Application Publication
(10) Pub. No.: US 2007/0245013 A1
(43) Pub. Date: Oct. 18, 2007

(54) Cross domain provisioning methodology and apparatus

(75) Inventors: Anil Saraswathy, Trivandrum (IN); Steve Tillery, Naples, FL (US)

Correspondence Address: NIXON & VANDERHYE, PC, 901 NORTH GLEBE ROAD, 11TH FLOOR, ARLINGTON, VA, 22203, US

(73) Assignee: Fischer International Identity LLC, Naples, FL (US)

(21) Appl. No.: 11/783,894

(22) Filed: Apr. 12, 2007

Related U.S. Application Data
(60) Provisional application No. 60/791,448, filed on Apr. 13, 2006.

(51) Int. Cl. G06F 15/173

(52) U.S. Cl. 709/223; 709/224

(57) ABSTRACT

A cross domain provisioning method, system and architecture for securely managing digital identities across a wide variety of IT systems, providing unified administration, compliance and auditing, and simplified connectivity. The combined use of certain aspects of the illustrative IDM Provisioning Platform (DataForum™), Connectivity Component Architecture, Design-Time Client Workflow Tool, and the use of digital certificates to secure cross domain communication channels, collectively offer a unique approach to solving cross domain provisioning problems.

### CROSS-REFERENCES TO RELATED APPLICATIONS

This application claims the benefit of Provisional Application No. 60/791,448, filed Apr. 13, 2006, the entire content of which is hereby incorporated by reference in this application.

### TECHNICAL FIELD

The illustrative embodiments generally relate to software-based resource provisioning. More particularly, the illustrative embodiments relate to software based provisioning methods and apparatus for controlling the provisioning of software resources among individuals across organizational boundaries.

### BACKGROUND AND SUMMARY

The primary driver for Identity Management (IDM) solutions is an organization's need to meet regulatory compliance requirements in order to avoid a failed security audit. Other benefits include streamlined administration processes, improved help desk operations, and the enhanced return on investment (ROI) associated with improving those processes. Without IDM, disparate administration groups are challenged with the responsibility of provisioning and de-provisioning user accounts, there is no central control, no central audit trail of the activity, no history, no accountability for why an account is created, or why particular permissions have been granted to various users. There is also no coordination or methodology linking a users accounts across platforms and systems. Typically, when employees, partners, or consultants leave the organization, their accounts are not de-provisioned on a timely basis creating regulatory compliance violations, best practice security violations, and in general generating huge security infrastructure problems.

Identity Management (IDM) may be viewed as the capability to manage user accounts across a wide variety of IT systems. An Identity Management (IDM) solution automates the administration processes associated with provisioning user accounts and entitlements or access rights, de-provisions accounts when a user leaves the organization, and offers approval services for these various provisioning processes. An IDM solution typically offers end-user self-service and delegated administration capabilities for managing user attributes, passwords, and user self-service provisioning requests for access to IT systems. An IDM solution also typically provides integration with a wide variety of IT systems that a given organization may be running. An IDM solution also typically offers Regulatory Compliance reporting and assessment capabilities.

Conventional Identity Management offerings are typically comprised of disparate point products such as password management, meta-directory, or provisioning products that were acquired to round out the IDM suite of features. Because these point products were designed separately, they require numerous integration points, multiple and complex administration, invasive agent technologies, and disparate audit log files, requiring a great deal of programming, and scripting to get the various point products to work together. Unfortunately, these solutions typically lack cohesion across IDM features, they lead to long implementations times, lower quality, and higher costs. After such a solution is deployed, the organization is typically left with a solution that is not maintainable, creating the need for repeat professional services work to maintain or extend the solution for future requirements.

These problems are magnified for organizations that operate distributed data centers, or have acquired companies with their own IT data centers, or organizations that outsource portions of their IT infrastructure, applications and services. There are also IDM Federation initiatives underway to solve cross domain authentication and single sign on (SSO) problems between business partners who wish to share services over the internet. These shared services are often provided by IT systems that require accounts, and entitlements. Federation protocols (security attribute markup language (SAML), WS-Federation, Liberty Alliance) offer cross domain authentication and SSO capabilities, however they do not provide robust IDM provisioning capabilities and streamlined approval processes required to grant access to cross domain IT system resources. To meet the needs of organizations that operate distributed data centers, or organizations that outsource portions of their IT infrastructure, applications and services, there exists a need to extend IDM provisioning capabilities across corporate boundaries targeting systems that run in other domains.

The exemplary, non-limiting, illustrative IDM suite described herein advantageously offers a system and architecture for securely managing digital identities across a wide variety of IT systems, providing unified administration, compliance and auditing, and simplified connectivity without the need for programming and scripting. The combined use of certain aspects of the inventors' illustrative IDM Provisioning Platform (DataForum™), Connectivity Component Architecture, Design-Time Client Workflow Tool, and the use of digital certificates to secure cross domain communication channels, collectively offer a unique approach to solving cross domain provisioning problems.

The illustrative DataForum™ integration engine architecture, the Connector Component Architecture, the Design-Time Client Workflow Configuration Tool, and the DataForum™ Web Services architecture, along with the use of public key infrastructure (PKI) backed security, enable IDM provisioning to be safely and confidently distributed cross domain.

A significant aspect of one illustrative implementation is the illustrative DataForum™ Extract Transform and Load (ETL) integration workflow engine. It is driven by customizable workflows which take the place of manually created scripts and custom programs. In this illustrative implementation, this engine replaces manual scripting and programming, which is typical of prior art solutions, with a GUI approach to configuring ETL operations required to solve integration problems.

The illustrative IDM Workflow Tool, a GUI tool, eliminates the need for programming or knowledge of various programming languages, scripting languages, or the syntax associated with them. This illustrative tool removes the need for those skills and greatly reduces problem determination time and debugging time. Since the workflows are maintained through the illustrative GUI tool, reliability issues associated with changing programs are virtually eliminated.

The illustrative Workflow Tool is used to configure attribute mapping, joining, and transforming IDM data from information sources to formats required by target systems. Again, typical prior art designs may require thousands of lines of program or script code to accomplish these tasks. Because the tool can directly interpret source and target schemas and present them to the designer in an easily understandable form, barriers to cross domain deployment are greatly reduced.

A further significant aspect of one illustrative implementation is the Design-Time component. It permits workflows to be designed, managed and stored locally on a client workstation. In this illustrative embodiment, when connectivity points, Import, Mapping, Export, and Trigger tasks have been configured and tested, the entire configuration is deployed” to the DataForum™ runtime environment via the Deploy Workflow operation.

A further significant aspect of one illustrative implementation is the Connectivity Component Architecture. Each connected system is configured with a connector component. Each type of connected system has a connector that is capable of interconnecting that systems unique interfaces and environment into the consistent DataForum™ environment. The illustrative system contains a library of such components designed for a variety of potential connected system types. New connectors can be created as needed as new system types surface.

Another significant feature of one illustrative Connectivity Component Architecture is its plug-n-play capability. Connectivity components can be added to a running solution without rebuilding the product to incorporate them, or without restarting a running solution to recognize and configure them.

A still further significant aspect of one illustrative implementation is that it greatly enhances the value of the Connectivity Component Architecture in cross domain environment, is its support for web services. DataForum™ components can be distributed to remote domains and controlled using web services. Web services are used to enforce security, confidentiality and integrity of data and control flow between DataForum™ and connected systems. DataForum™'s Audit Trail Service captures the detail around IDM events and stores it in the IDM audit trail database. In an illustrative implementation, the DataForum™ product may be designed with over 90 different IDM events configured to be captured as workflows execute. Prior art systems typically use piecemeal audit trail components, not integrated into a consistent and uniform whole.

### BRIEF DESCRIPTION OF THE DRAWINGS

FIG. 1 is an illustrative block diagram of an IDM Integration Engine Platform;

FIG. 2 is an illustrative block diagram of an Engine Platform—Design Time;

FIG. 3 is an illustrative screen display for Source System Schema Refresh—Design Time;

FIG. 4 is an illustrative screen display for IDM Workflow Mapping—Design Time;

FIG. 5 is an illustrative block diagram of the Engine Platform—Run Time;

FIG. 5A is an example screen from the Client-Time Workflow Configuration Tool used for re-configuring these events to be on (capture) or off (don't capture);

FIG. 6 is an illustrative block diagram of the Connectivity Component Architecture;

FIG. 7 is an illustrative block diagram of Cross Domain Provisioning; and

FIG. 8 is an illustrative block diagram of Cross Domain Provisioning Example Flow.

FIG. 9 shows an illustrative connected system XML configuration file;

FIG. 10 shows an illustrative refresh schema request;

FIG. 11 shows an illustrative refresh schema response (partial response as the entire response may be over a thousand lines);

FIG. 12 shows an exemplary trigger configuration file;

FIG. 13 shows exemplary RDBMS event trigger information; and

FIG. 14 shows an exemplary Import XML stream.

### DETAILED DESCRIPTION OF ILLUSTRATIVE IMPLEMENTATION

Architecture Overview

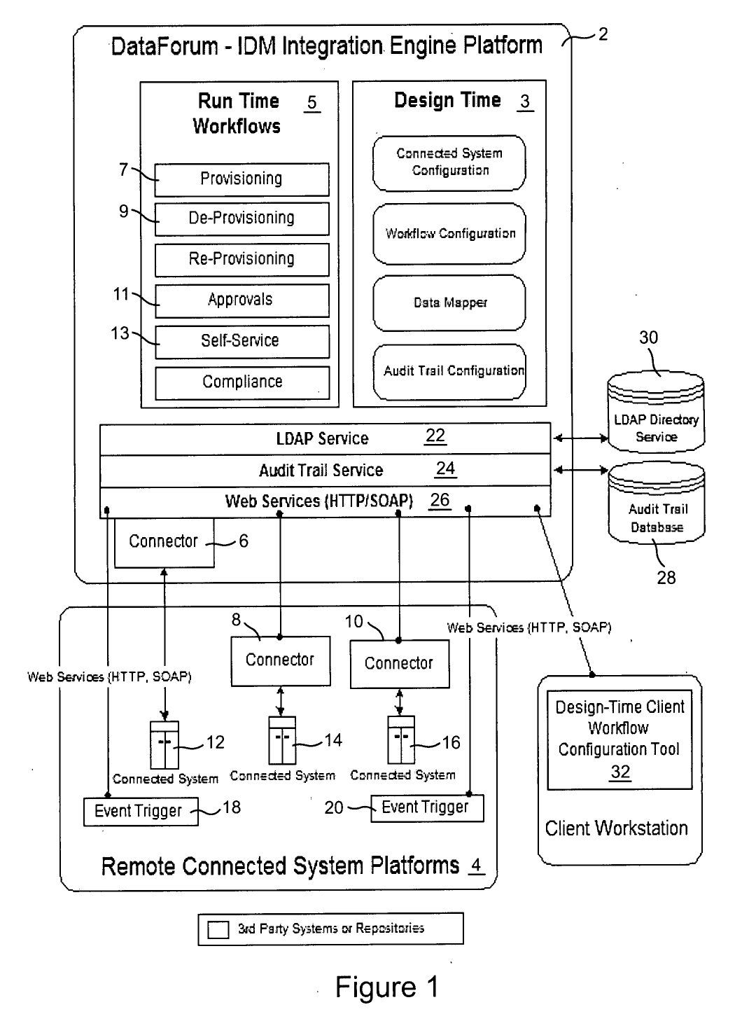

IDM is typically viewed as a security problem. In reality, IDM is a system integration problem with digital identities being the primary information object. For this reason, the illustrative Identity suite was built on an integration engine called DataForum™ 2 shown in FIG. 1. DataForum™ 2 offers powerful extraction, transformation, and load (ETL) capabilities that facilitate the integration with a wide variety of connected systems where user accounts and entitlements need to be managed. A significant aspect of one illustrative IDM suite is that all of the IDM features are implemented in the form of DataForum™ workflows that share the services of one common workflow engine, a common set of connectivity components, a common set of secure web services capabilities, a common administration capability, a centralized audit trail database service, as well as the ETL capabilities of the DataForum™ engine.

Although the acronyms used throughout this description are well known to those skilled in the art, the acronyms used herein should be interpreted as follows.
IT—Information Technology
PKI—Public Key Infrastructure
ETL—Extract Transform and Load. The functions performed when pulling data out of one database and placing it into another of a different type.
GUI—Graphical User Interface
LDAP—(Lightweight Directory Access Protocol) A protocol used to access a directory listing. LDAP support is being implemented in Web browsers and e-mail programs, which can query an LDAP-compliant directory. It is expected that LDAP will provide a common method for searching e-mail addresses on the Internet, eventually leading to a global white pages.
LDAP is a sibling protocol to HTTP and FTP and uses the ldap://prefix in its URL.
SOAP—(Simple Object Access Protocol) is a standard for exchanging XML-based messages over a computer network, normally using HTTP. SOAP forms the foundation layer of the web services stack, providing a basic messaging framework that more abstract layers can build on.
HTTP
(HyperText Transfer Protocol) The communications protocol used to connect to servers on the Web. Its primary function is to establish a connection with a Web server and transmit HTML pages to the client browser or any other files required by an HTTP application. Addresses of Web sites begin with an http://prefix; however, Web browsers typically default to the HTTP protocol. For example, typing www.yahoo.com is the same as typing http://www.yahoo.com.
HTTP is a “stateless” request/response system. The connection is maintained between client and server only for the immediate request, and the connection is closed. After the HTTP client establishes a TCP connection with the server and sends it a request command, the server sends back its response and closes the connection (see cookie).
TCO—(Total Cost of Ownership) is a type of calculation designed to help consumers and enterprise managers assess direct and indirect costs as well as benefits related to the purchase of computer software or hardware. A TCO ideally offers a final statement reflecting not only the cost of purchase but all aspects in the further use and maintenance of the computer components considered. This includes training support personnel and the users of the system. Therefore TCO is sometimes referred to as total cost of operation.
UI—User Interface
XML
(eXtensible Markup Language) An open standard for describing data from the W3C. It is used for defining data elements on Web pages and business-to-business documents. XML uses a similar tag structure as HTML; however, whereas HTML defines how elements are displayed,
XML
defines what those elements contain. While HTML uses predefined tags, XML allows tags to be defined by the developer of the page. Thus, virtually any data items, such as “product,” “sales rep” and “amount due,” can be identified, allowing Web pages to function like database records. By providing a common method for identifying data, XML supports
business-to-business transactions and has become “the” format for electronic data interchange and Web services (see XML vocabulary, Web services, SOA and EDI).
ADSI
(Active Directory Services Interface) A programming interface from Microsoft for accessing the Microsoft Active Directory (Windows 2000), the directory within Exchange and other directories via providers. For example, an ADSI LDAP provider converts between LDAP and ADSI.
Based on
COM, ADSI can be used in Visual Basic and other programming languages.
See Active Directory and LDAP.
AD—Active Directory. The name of Microsoft's directory technology.
JDBC
(Java DataBase Connectivity) A programming interface that lets Java applications access a database via the SQL language. Since Java interpreters (Java Virtual Machines) are available for all major client platforms, this allows a platform-independent database application to be written. In 1996, JDBC was the first extension to the Java platform. JDBC is the Java counterpart of Microsoft's ODBC. See ODBC.
SSH
(Secure SHell) Software that provides secure logon for Windows and Unix clients and servers. SSH replaces telnet, ftp and other remote logon utilities with an encrypted alternative
DN—distinguished name
A name given to a person, company or element within a computer system or
network that uniquely identifies it from everything else. The key word here is “distinguished,” which means “set apart from the crowd.”
HR—Human Resources
RDBMS
(Relational DataBase Management System) See relational database and DBMS.
MSSQL—Microsoft SQL Server
SQL
(Structured Query Language) Pronounced “S-Q-L” or “see-quill,” a language used to interrogate and process data in a relational database.

DataForum™ may be considered middleware that runs on separate computer platforms apart from the remote systems and platforms where digital identities need to be managed. In accordance with an exemplary implementation, DataForum™ is comprised of triggers, workflows, connectors, an LDAP directory service (IDM store), and a relational database where IDM audit trail information is captured representing the history of IDM events across all connected systems.

IDM Workflows process IDM events that originate in the remote connected systems. Example IDM events may include events like provision a new user 7, de-provision a user who has left the organization 9, password change requests, change user entitlement or access rights, change user telephone number or e-mail address, self-service provisioning 13, approve a provisioning request 11, and many more.

As shown in FIG. 1, DataForum™ 2 offers a design-time 3 vs. run-time 5 concept which is strategic to faster deployment times, a maintainable solution that is easily extended to address future IDM requirements, and a lower TCO as compared to competitive IDM solutions. Design-time 3 is used to configure and deploy IDM workflows; run-time 5 is used to execute them. The concepts are discussed in more detail below.

In the “Remote Connected System Platform” area 4 (bottom of FIG. 1) we see connected systems 12, 14, 16, connectors 6, 8, 10, and IDM event triggers 18, 20. Connectors 6, 8, 10 represent their designated connected systems 12, 14, 16, establishing connectivity to these systems, and executing a number of various operations against these source and target IDM systems. Triggers 18, 20 are deployed to these connected system platforms to listen for, and process IDM events which are typically add, modify, or delete events against IDM related information. Triggers capture IDM events and launch appropriate run-time IDM workflows enabling the solution to process IDM events in near real time.

Many competitive IDM solutions do not offer event-based capabilities. Instead, they perform a batch oriented full pull of connected system repositories and run a comparison against a private copy to assess change. Competitive solutions that do offer event capabilities do not offer a design-time concept for trigger configuration and automatic deployment. Instead, scripting is used as a means for trigger configuration something we've eliminated with the use of the illustrative Design-Time Provisioning Tool.

In FIG. 1 toward the bottom of the “DataForum™—IDM Integration Engine Platform” 2 we see the LDAP Service 22, the Audit Trail Service 24, and the Web Services layer 26 with support for HTTP/SOAP. DataForum™ offers a Service Oriented Architecture so many of the components communicate over secure Web Services connections. Examples of this are Triggers and remotely deployed Connector components. Triggers communicate with the DataForum™ engine over this Web Services layer 26. Remotely deployed connecters 8, 10 receive DataForum™ connected system requests over the Web Services layer 26. Web services 26 may also be leveraged by a connector 6 for integration with web services compliant connected systems 12.

The Audit Trail Database service 28 is used to capture information about all IDM events, across all IDM connected systems. By designing the Audit Trail service 24 into the DataForum™ Engine 2, its services are available to all IDM features implemented in the form of DataForum™ workflows. As DataForum™ workflows process connected system IDM events, the audit trail service 24 is driven at strategic points to capture the “Who, What, Where, and Why” information around all of these IDM events. The illustrative implementation is believed to be unique in this area in that it captures a consolidated view of all IDM events in a relational database. Many competitive product suites were put together through the acquisition of point products, each of which generate log files that need to be post-processed, and often have inconsistent or missing IDM audit trail information.

The illustrative IDM store is an LDAP compliant directory service 30. This is typically a directory service like Microsoft Active Directory, or the SunOne LDAP server. DataForum™ uses the LDAP service 22 to manage and access workflow configuration and operational information. User Identity information, user connected system account information, connected system password policy information, and other design-time and run-time configuration information is also managed in the LDAP directory service.

Another differentiating feature of the illustrative IDM suite is the extraction, transformation, and load (ETL) capabilities built into DataForum™. After experience and research with a wide variety of integration tools, over 50 transformation capabilities have been identified and made available to the illustrative Design-Time Client Workflow Configuration Tool. Competitive offerings involve the use of programming or scripting to solve integration related problems, integration issues are addressed in an illustrative implementation with our GUI Workflow Configuration Tool.

A significant aspect of the illustrative Cross Domain Provisioning capability is that IDM feature set has been implemented in the form of customizable workflows that run on an ETL integration engine (DataForum™), eliminating the need for scripting and programming with a GUI approach to configuring ETL operations required to solve integration problems.

Fundamental Operation—Design Time

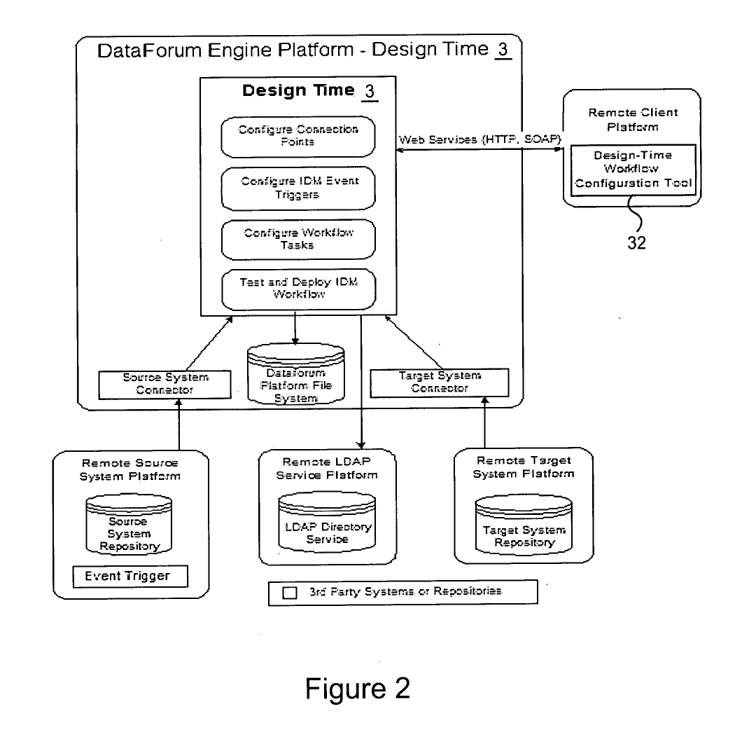

As indicated in FIG. 2, DataForum™ workflows consist of tasks that process IDM events which occur in the remote connected systems participating in the IDM solution. A basic IDM workflow would consist of a source system export task, a data mapping task, and a target system import task. DataForum™ has a design-time vs. run-time concept where during design time, the Design-Time Client Workflow Configuration Tool 32 is used to configure these tasks as well as connection points, and IDM event triggers associated with the workflow.

During this design time process, the workflow configuration client 32 uses web services (HTTP/SOAP) to communicate with the DataForum™ engine. Over this web services connection, the client 32 can access DataForum™ services to access design-time configuration information required for new IDM workflow processes. Certain of the Tool's unique capabilities associated with the tool's user interface are described below.

Another significant aspect of the illustrative solution is that the IDM workflow designer eliminates the need for programming or knowledge about various programming languages, scripting languages, or the syntax associated with them. Our illustrative Tool removes the need for those skills as well as problem determination time frames related to debugging programs, and the reliability issues associated with changing programs.

The exemplary Workflow Tool queries the DataForum™ server for a list of connected system objects, existing triggers, and existing workflow objects as they may be used in the creation of new IDM workflows. The designer typically selects one or more source systems where IDM events may drive the execution of the new IDM workflow.

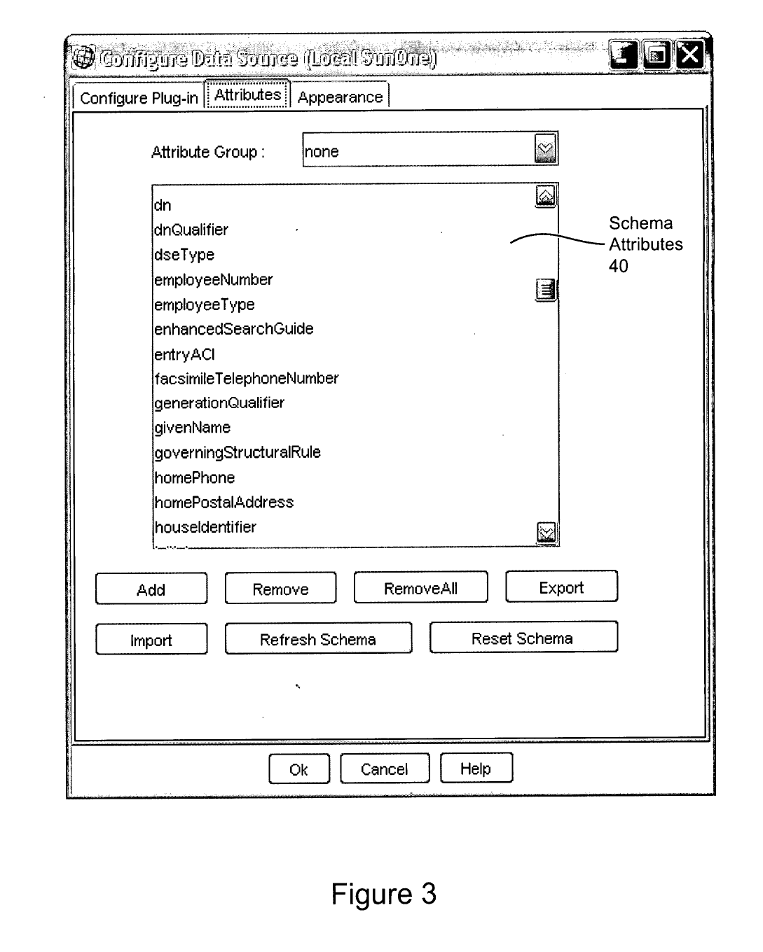

As indicated in FIG. 3, the source system schema is then refreshed. Competitive products require connected system schema information be manually entered or defined as part of scripts or programs. DataForum™ offers a Design-Time service for real-time schema discovery and returns up to date connected system schema information to our Configuration Tool. FIG. 3 is an example of a schema refresh operation against a source system. The workflow designer would then browse through the schema attributes 40 selecting those attributes that will be used as source fields in the New IDM workflow.

The illustrative Design-Time Configuration Tool is uniquely used to configure attribute mapping, joining, and transforming IDM data into formats required by target systems. Again, competitors may require thousands of lines of program or script code to accomplish these tasks resulting in an un-maintainable solution.

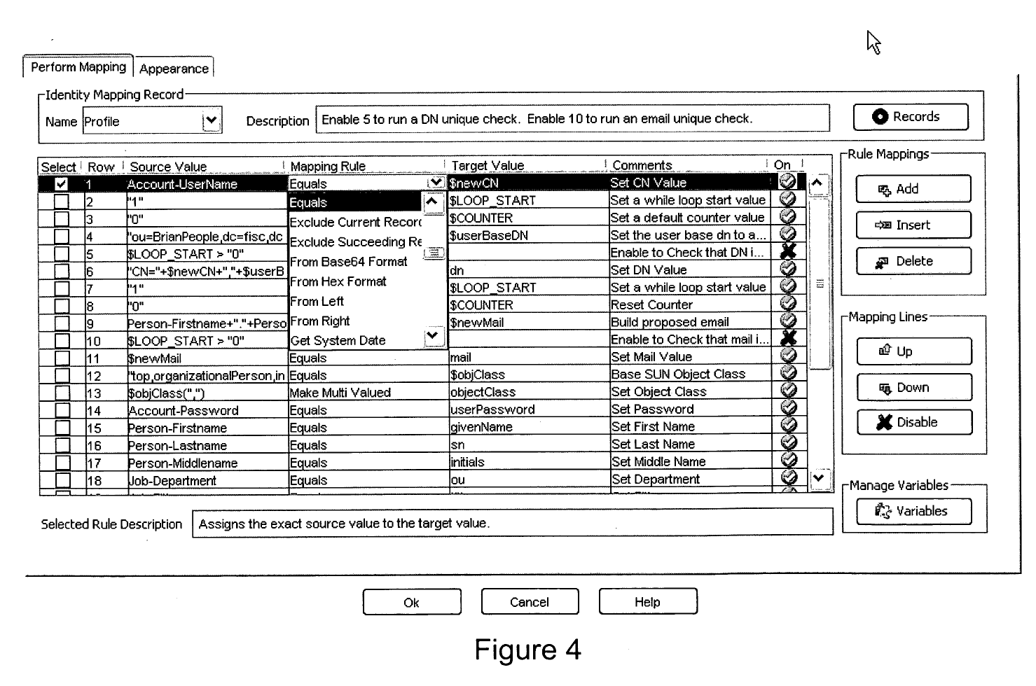

In FIG. 4, we have an example of our illustrative Configuration Tool's workflow mapping process. Remember we said that IDM workflows consist of tasks. Each of the lines represents one illustrative operation associated with an IDM Workflow Mapping Task. As shown in FIG. 4, each operation has a Source Value column, a Mapping Rule column, a Target Value column, and a Comments column to describe the operation. The Source Value is configured using the source system schema refresh and attribute selection process. A similar process was executed for the Target Value column.

The Mapping Rule column represents a drop down list of over 50 different alternatives for doing data mapping, joining operations, transformation operations, and logic constructs like if-then-else. The table below contains an illustrative list of mapping methods. The Mapping Rule column also offers alternatives for configuring connected system queries to bring in additional information required in an IDM provisioning process. The use of search filters and complex queries may also be configured using our GUI tool. Any connected system supported by DataForum™ can become a source of additional information for the IDM Workflow process.

With this approach to integration, there is no requirement to manually define or program connected system schema and attribute information, no need to program or script, and no need to understand the syntax associated with various scripting languages, or debug programming problems or issues related to bad schema definitions. The result is a significant improvement in deployment times and a more reliable solution.

IDM Mapping Methods

Add Field Value Add Prefix Add Suffix

| | | |
|---|---|---|
| Add to Value | Allow Characters | Assign to Role |
| Between | Concat Value | Contains |
| Count Occurrences | Create IdM Account Relation | Create Md5 Format |
| Create SHA digest | Create Unique Dated Value | Create Unique Identifier |
| Delete IdM Account Relationship | Delete Value | Divide Field Value |
| Dynamic Output Record | Else | Ends With |
| Equals | Exclude Current Record | Exclude Succeeding Record |
| Exit | From Base64 Format | From Hex Format |
| From Left | From Right | Get Source System Name |
| Get System Date | Get Target System Name | Get Value Index |
| If | Increment Value | Is Empty Valued |
| Is Multi Valued | Is Single Valued | Lookup Data |
| Make Lowercase | Make Multi Valued | Make Single-Valued |
| Make Uppercase | Multiply Field Value | Pad Left |
| Pad Right | Pick From String | Read Entry |
| Remove Characters | Remove Duplicate Values | Remove Field |
| Rename | Replace Parameters | Replace Value |
| Return | Sort Ascending | Sort Descending |
| Starts With | Strip Leading Chars | Strip Trailing Chars |
| Subtract Field Value | Three Way Cipher Decrypt | Three Way Cipher Encrypt |
| To Base64 Format | To Big Int String | To Hex Format |
| Trim Value | Truncate Value | Value Exists |
| While | | |

Another unique illustrative Design-Time feature is the “Deploy Workflow” operation. As the design-time process evolves, workflow configurations are temporarily managed and stored on the client workstation 32 where the Configuration Tool runs. When connectivity points, Import, Mapping, Export, and Trigger tasks have been configured and tested, the entire configuration is “Deployed” to the DataForum™ Run-Time environment.

During the “Deploy” operation, workflow configuration files, task configuration files, trigger configuration files are sent to DataForum™ over the web services connection 26 between the Configuration Tool and the DataForum™ server. The configuration files are either stored in the DataForum™ platform file system, or on a shared network drive. Properties and pointers describing the configuration files are stored in DataForum™'s LDAP Directory service 30. IDM event triggers are initiated, and depending on the trigger type, trigger files are deployed to the appropriate connected system platform making the IDM workflow ready to process IDM events.

Operation—Run Time

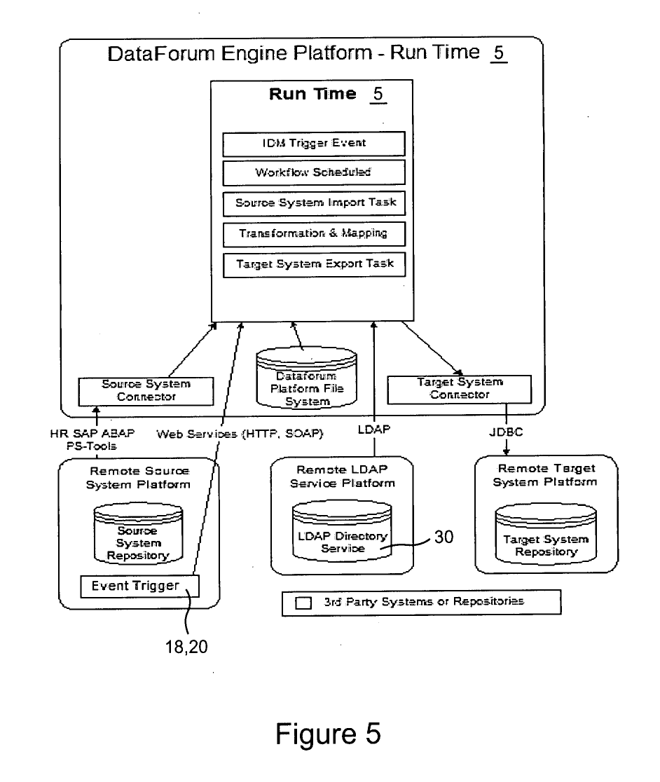

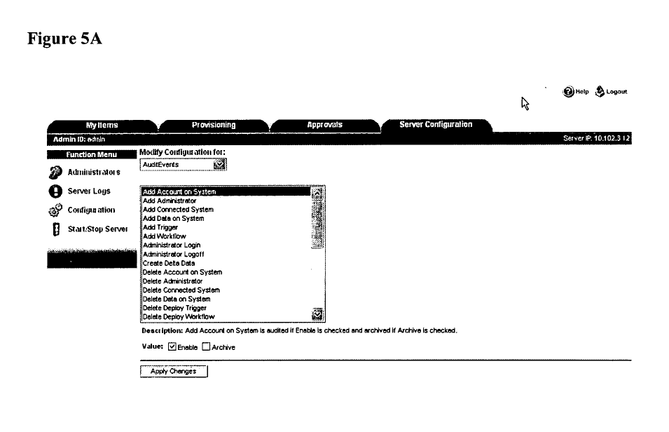

As indicated in FIG. 5, after IDM workflows have been deployed to the DataForum™ run-time environment 5, they are ready for execution.

DataForum™ workflows are started by DataForum™ triggers. Depending on the type of connected system, triggers 18, 20 may be running remotely on a connected system platform, they may be scheduled over a communications connection from the DataForum™ platform, or they can be a time-of-day event trigger launching IDM workflows that need to run on time-of-day dependant intervals.

In FIG. 5 we have an example of a trigger running on a remote connected system platform listening for specific changes in that particular connected system. A change might be a new entry being added to a relational database table that represents a new employee. The new employee may need access rights provisioned to a target connected system so they can log into a network. In this example, the trigger fires and the trigger configuration file is executed from the remote platform. The trigger application establishes a web services connection with DataForum™ and sends IDM event information along with the appropriate workflow configuration properties that were configured during Design-Time. DataForum™ performs a lookup in its LDAP directory service 30 retrieving the information required to schedule and execute the appropriate IDM workflow.

The LDAP directory 30 provides pointers to the appropriate workflow configuration file, and task configuration file that describe the details for connected system export operations, workflow mapping task operations, as well as connected system import task operations.

Source system export tasks drive DataForum™ connectors to obtain the necessary input for processing the IDM event. The data is brought into an object we call a DataForum™ DataHub. DataHubs are used to store information from workflow tasks and are used as placeholders where a workflow task can send or receive data as an XML document.

The DataHub has an associated XML schema so all imported data from a connected system is transformed into a DataHub XML schema format. The workflow mapping tasks execute all of the transformation and mapping rules that were configured using the Design-Time Workflow Configuration Tool. The result is then transformed into the necessary data format required by the target connected system. The last set of tasks would be the import tasks. Import tasks drive DataForum™ connectors to perform the necessary target system updates, possibly adding a new user to a network security system enabling them to login to the network.

Another unique aspect of our illustrative solution is that as these IDM workflow tasks execute they drive DataForum™'s “Audit Trail Service”, to capture the detail around these IDM events and store it in the IDM audit trail database. We ship the DataForum™ product with over 90 different IDM events configured to be captured as workflows execute. The UI shown in FIG. 5A is an example screen from the Client-Time Workflow Configuration Tool used for re-configuring these events to be on (capture) or off (don't capture). The table below includes an illustrative list of IDM events.

IDM Event List

| | |
|---|---|
| Login | Add Target to Policy |
| | Remove Target from |
| Logoff | Policy |
| | No Policy |
| Search Directory | Determination |
| | Separation of Duty |
| Add Profile | Enforcement |
| Modify Profile | Add Password Policy |
| | Modify Password |
| Delete Profile | Policy |
| | Delete Password |
| Disable Profile | Policy |
| | Add Password Policy |
| Enable Profile | Group |
| | Modify Password |
| Add FISCIdentity Role | Policy Group |
| | Delete Password |
| Modify FISCIdentity Role | Policy Group |
| Delete FISCIdentity Role | Start Server |
| Add Licensing | Stop Server |
| | Modify Server |
| Modify Licensing | Configuration |
| Delete Licensing | Add Workflow |
| Enable User Account | Modify Workflow |
| Disable User Account | Delete Workflow |
| Lock User Account | Deploy Workflow |
| | Delete Deploy |
| Unlock User Account | Workflow |
| Reset User Password | Run Workflow |
| Add Password Management User Association | Add Trigger |
| Delete Password Management User Association | Modify Trigger |
| Authenticate Password Management User | Delete Trigger |
| Modify Security Questions | Deploy Trigger |
| | Delete Deploy |
| Challenge Response Password Reset | Trigger |
| Webservice Password Reset | Enable Trigger |
| Password Reset with Expiry | Disable Trigger |
| Modify Password Management User Association | Sync Contacts |
| Add Account on System | Sync Calendar |
| Modify Acocunt on System | Reset Contacts |
| Delete Account on System | Reset Calendar |
| Search Data on System | Approve Request |
| Add Data on System | Reject Request |
| | Escalate Request by |
| Modify Data on System | User |
| Delete Data on System | Escalate Request by |
| | System |
| | Delegate Request by |
| Run API on System | User |
| | Delegate Request by |
| Create Delta Data | System |
| Add Connected System | Add Approval Rule |
| Modify Connected System | Modify Approval Rule |
| Delete Connected System | Delete Approval Rule |
| Create Policy | Approver Login |
| Change Policy | Approver Logoff |
| Delete Policy | Run Report |
| Create Policy Set | Add Report |
| Change Policy Set | Modify Report |
| Delete Policy Set | Delete Report |
| Add Policy Member | Add Administrator |
| Remove Policy Member | Modify Administrator |
| Add Acceptance Rule to Policy | Delete Administrator |
| Remove Acceptance Rule from Policy | Administrator Login |
| Add Denial Rule to Policy | Administrator Logoff |
| Remove Denial Rule from Policy | |

Connectivity Component Architecture

In an illustrative implementation, connectivity components are used to access source and target connected system platforms where IDM account and entitlement information is being managed. Connectivity components are driven by DataForum™ 2, at both Design-Time and Run-Time, to interpret DataForum™ service requests and implement connected system specific APIs to perform those requests. There are two parts to all connectivity components, the DataForum™ Connector Services layer 45, and the System Specific Connectivity layer 47.

The DataForum™ Connector Services layer 45 in an illustrative implementation exposes the following services:
1. Verify connected system connection parameters
2. Verify connected system credentials (Login, Logout)
3. Verify connected system account (Search)
4. Verify connected system enable/disable status
5. Enable a connected system account
6. Disable a connected system account
7. Change or Set the password in a connected system account
8. Create connected system session
9. Terminate connected system session
10. Login to a connected system
11. Export data from a connected system (Full, Delta)
12. Import data to a connected system (Full, Delta, Add, Modify, Delete)
13. Retrieve connected system schema

Services like (#13) Retrieve connected system schema may be driven by DataForum™ at Design-Time while configuring workflow mapping rules. Rather than manually entering or scripting connected system specific schema and attribute formats, our DataForum™ platform can receive a web services request from our Design-Time Workflow Configuration Tool to obtain connected system schema and attribute information required for workflow mapping operations. When schema requirements change in connected systems, the Tool can also request a refresh obtaining the updated connected system schema information.

Services like (#12) Import data to a connected system might be driven by DataForum™ at Run-Time to update a target connected system as part of an IDM workflow process. The details of the Import operation, the entry ID and attribute information are defined in XML statements and streamed to connectivity components as part of the Import request.

Regardless of the DataForum™ service, the connectivity component must interpret the request and execute the appropriate system specific services required to implement the request. For example, on Microsoft Active Directory (AD) the connectivity component for AD would implement Active Directory Service Interfaces (ADSI) and the Lightweight Directory Access Protocol (LDAP) as AD supports both access techniques. A connectivity component for a relational database might implement the Java Database Connectivity (JDBC) access technique. A connectivity component for a UNIX platform might implement Secure Shell (SSH) services to integrate and mange remote UNIX platforms. Considering the wide variety of applications and systems running in various organizations, the potential number of different connectivity components could be in the thousands.

IDM solutions have connectors (or agents) in one form or another that serve the purpose of integrating and communicating with systems where IDM credentials are being managed. The illustrative DataForum™ architecture is unique in the way we allow connectivity components to be created, configured, deployed, and also in the way we share their services across all IDM features, at Design-Time, as well as at Run-Time.

In an illustrative implementation, connectivity components are not actually part of the DataForum™ engine. They're packaged separately in the form of Jar files. They can be installed on the DataForum™ platform, or remotely on remote or connected system platforms. These components can be created by the applicants' assignee, Fischer International, and distributed with the Fischer IDM Product suite, or they can be created by an organization running the solution, or by a 3^{rd} party system integrator.

Another unique point about the illustrative connectivity component architecture is its plug-n-play capability. Connectivity components can be added to a running solution without rebuilding the product to incorporate them, or without restarting a running solution to recognize and configure them. When a connectivity component (jar file) is added to a running DataForum™ platform, it is ready to be configured using the Workflow Configuration Tool (Design-Time). The required configuration parameters are part of the jar file. An instance of these parameters representing the target connected system is stored in the DataForum™ LDAP directory. Connected system parameters vary between types of connected systems, but they contain things like IP-Address, Host name, Port, and Administrative Account Credentials. For example, an LDAP connected system contains information such as Base DN for searches; a database connected system contains information about the database schema and table names.

Competitive solutions may use programming and scripting languages to define connected system information. In addition to the usual problems associated with the deployment and maintenance of program script code, administrative account credentials are defined, in plain text in script code, and separate scripts for each connected system exist, a huge security issue. DataForum™ keeps this information encrypted in its LDAP directory server.

A further unique point that impacts the value of our connectivity component architecture, and the flexibility around integration offered by the DataForum™ platform, is its support for web services. We mentioned that connectivity components can be deployed on remote platforms, or on remote connected system platforms (remote from the DataForum™ platform). When connectivity components are deployed remotely, DataForum™ uses its web services architecture to drive them and control them. The XML payload mentioned above is streamed to remote connectivity components over a secure web services (HTTP/SOAP) connection.

Cross Domain Provisioning

To meet the needs of organizations that operate distributed data centers, or organizations that outsource portions of their IT infrastructure, applications and services, there exists a need to extend IDM provisioning capabilities across corporate boundaries targeting systems that run in other domains. There is also a need to distribute the administration and workflow configuration management of these solutions to cross domain organizations.

There are also Federation initiatives underway to solve cross domain authentication and SSO problems between business partners who wish to share services over the internet. Federation protocols (SAML, WS-Federation, Liberty Alliance) offer cross domain authentication and SSO capabilities, however these protocols do not provide for robust IDM provisioning capabilities and streamlined approval processes required to grant access to cross domain IT system resources.

The illustrative DataForum™ integration engine architecture, the Connector Component Architecture, the Design-Time Client Workflow Configuration Tool, and the DataForum™ Web Services architecture, along with the use of digital certificate based security, enable IDM provisioning to be distributed cross domain. In an illustrative implementation, these characteristics of DataForum™ make it an ideal candidate as a Software as a Service (SaaS) methodology when utilized by a company providing IT provisioning services to another company.

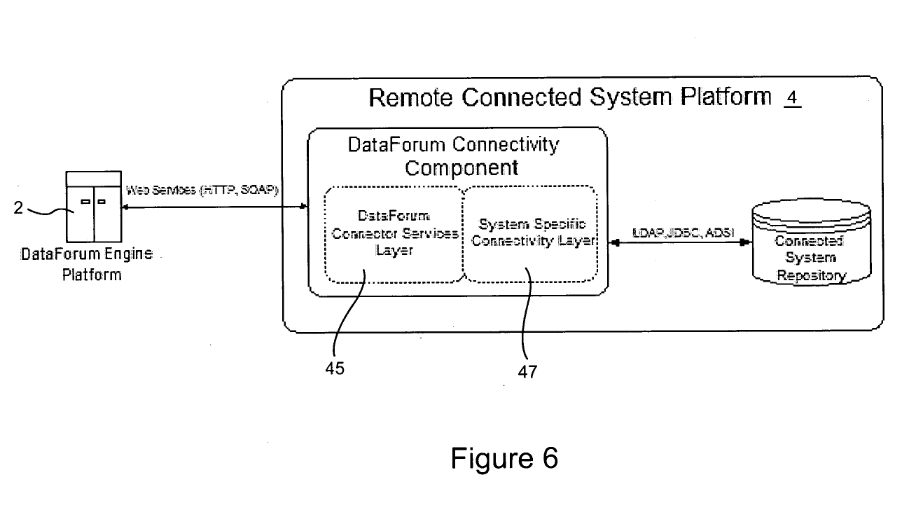

In FIG. 7, in Domain-1 (left) we have Company-A running an IDM provisioning solution using the DataForum™ Integration Engine, with local connected systems, as well as integration to applications running in Company-B, in Domain-2 (upper right). The IDM provisioning workflows running in Company-A were configured by Company-A using DataForum™'s Design-Time Client Workflow Tool. In this example, Company-A might be out-sourcing certain IT services creating a need to provision user accounts and entitlement information for certain applications running in Company-B. The DataForum™ Connectivity Component architecture enables the connectivity component to be deployed and configured on the remote platform at Company-B. The Design-Time Tool enables Company-A to discover the schema associated with systems running in Company-B, and also to use a GUI approach for configuring IDM provisioning workflows. When the IDM provisioning workflows execute, Web services are used to provide communications between the DataForum™ Integration Engine running at Company-A, and the connector component running at Company-B. The DataForum™ Connector Component architecture uses digital certificates to offer strong authentication and privacy over these web services connections. So the combined use of the DataForum™ Connectivity Component Architecture with digital certificates is strategic to enabling cross domain provisioning.

In another example, Company-A might be an HR service provider to Company-C. When Company-C hires or terminates employees, these HR events occur in the HR system running at Company-A. The DataForum™ Integration Engine is driven to process Company-C's HR events. It was configured to route Company-C's HR events over the web services connection to Domain-3 where another Instance of the DataForum™ Integration engine is running. In this case, a DataForum™ connectivity component representing DataForum™ (ourselves) implements the Certificate based security used for privacy and authentication between the two instances of DataForum™ (Company-A_Company-C). In this example, IDM Provisioning administration for Company-C was distributed to Company-C where an instance of the Design-Time Client Workflow configuration tool was used to configure IDM provisioning workflows on the instance of DataForum™ running at Company-C. Company-A doesn't need to know about how Company-C handles its IDM Provisioning events, Company-C's IDM provisioning policies, connected systems, their approval processes, or how they meet regulatory compliance requirements for IDM. And programming is not required for integration with cross domain systems.

At the bottom of FIG. 7 we show an instance of an illustrative Design-Time Client Workflow Tool with a secure web services connection to both instances of DataForum™ running at Company-A and Company-C. IDM workflow administration and the use of this tool can be centralized where a service provider (Company-A might own the administration for remote instances of DataForum™, or the use off the tool can also be distributed with DataForum™ (Company-C). In either case, the tool is a web services client to DataForum™ and certificate based security is used for authentication and privacy. A more detailed example follows.

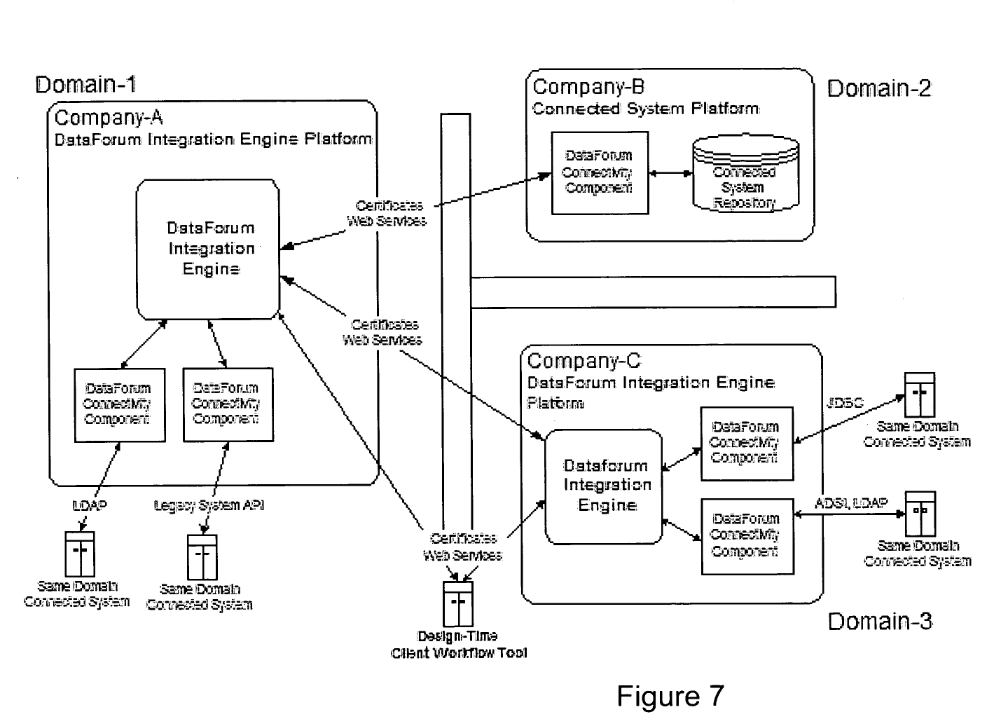

We've included an example of a basic IDM Cross Domain Provisioning problem. In FIG. 8 we have two IT data centers referred to as Domain-1 (Company-A) and Domain-2 (Company-B). In this example, we can presume that Company-B is providing a service to Company-A. In order for Company-A's employees to use the service at Company-B, they must request the service, have the request approved, and then be registered in the LDAP directory service in Company-B. Our Design-Time Workflow Tool, our DataForum™ engine, our Connectivity Component Architecture, along with the use of web services and digital certificates is used to automate the process.

In the example in FIG. 8, Company-A is running an instance of the DataForum™ provisioning engine with connectivity to an RDBMS (L2, L3). The connectivity was established through the DataForum™ Connectivity Component Architecture. We've also deployed a remote Connectivity Component to Company-B, for access to Company-B's LDAP compliant directory service, required for Company-A employees to access the service at Company-B. A Web services communication link (L4, SOAP) is used between Company-A and Company-B. Digital certificates are used over the link (L4) for privacy and authentication of the components at both ends of the link (L4).

Although FIG. 8 shows one simple workflow between Company-A and Company-B, we can presume that Company-A may be running the DataForum™ platform for a wide variety of connected systems or business partners. The design of the DataForum™ platform enables Company-A to use the Workflow Tool to extend the solution to Company-B without restarting the running solution, without a production interruption of service to other business partners, and without any integration programming or scripting typically required in other solutions.

Cross Domain Provisioning—Design-Time Example Flow

To extend the solution to Company-B, the DataForum™ Design-Time Workflow Configuration Tool was used to configure the Cross Domain Provisioning process between Company-A and Company-B. The Design-Time Workflow Tool is a client of the DataForum™ provisioning engine. The communications link between the Tool and DataForum™ is a web services link (L1).

The next several Design-Time steps are part of building a workflow job which typically consists of “Export” tasks, “Mapping & Transformation” tasks, and “Import” tasks. For our example, our workflow (job) will show one connected system export task, one mapping task, and one target system import task.

Design-Time Step 1—Create Connection Points

The workflow tool issues a request to DataForum™ to create a DataForum™ connectivity point for Company-A's RDBMS system, and Company-B's LDAP compliant directory service. The following parameters are passed from the Workflow Tool to DataForum™:
1. Authentication token
2. Connected system name
3. Connected system type (JDBC, LDAP)
4. Connected system trigger (RDBMS)
5. Connected system description
6. Connected system config xml

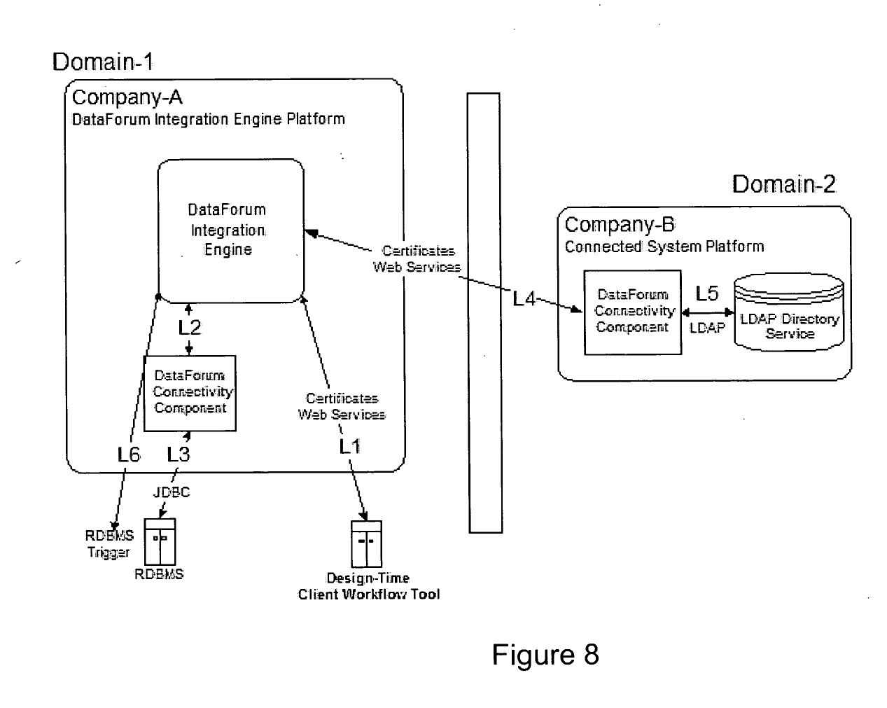

The connected system name will be used later when configuring the source and target connected systems of a workflow process. The type pertains to the type of connectivity component (LDAP, ADSI, JDBC, OTHERS). The trigger type pertains to the type of event trigger used to launch workflows to process provisioning events. In our example, it would be the RDBMS trigger. These parameters along with the connected system XML configuration file, containing connection and credential information, is streamed over the web services connection (L1), to DataForum™, where the connection points are created. An illustrative connected system XML configuration file is shown in FIG. 9.

The connection points are established and the Workflow Tool can be used to test connectivity to these new connection points, certifying that the newly configured connection parameters are correct, and that a session can be established to the new connected system.

Problems related to connected system configurations, TCP/IP addresses, ports, and the use of connected system administrative credentials can be tested at the time they're being configured. Competitive products typically have no Design-Time concept, they embed connection parameters in script code, and can't test connectivity until provisioning processes actually run making problem determination much more complicated, especially in a Cross Domain world. Competitive products also typically embed connected system administrative credentials in script code, creating security issues for the organization running the solution. DataForum™ doesn't require scripting and stores these credentials encrypted, in its LDAP directory.

Design-Time Step 2—Connected System Schema Refresh

This feature is significant to a Cross Domain Provisioning solution because the connected system schema, in the other domain, is unknown. Using the DataForum™ Workflow Tool, and the DataForum™ Connectivity Component Architecture, we can discover the schema in the Cross Domain system, bring those schema elements into our Workflow Tool, making the attributes available to attribute mapping processes required to govern the behavior of IDM provisioning. Again, competitive products may manually enter schema into scripts or configuration files with no ability to dynamically discover schema for the purpose of workflow provisioning process configuration.

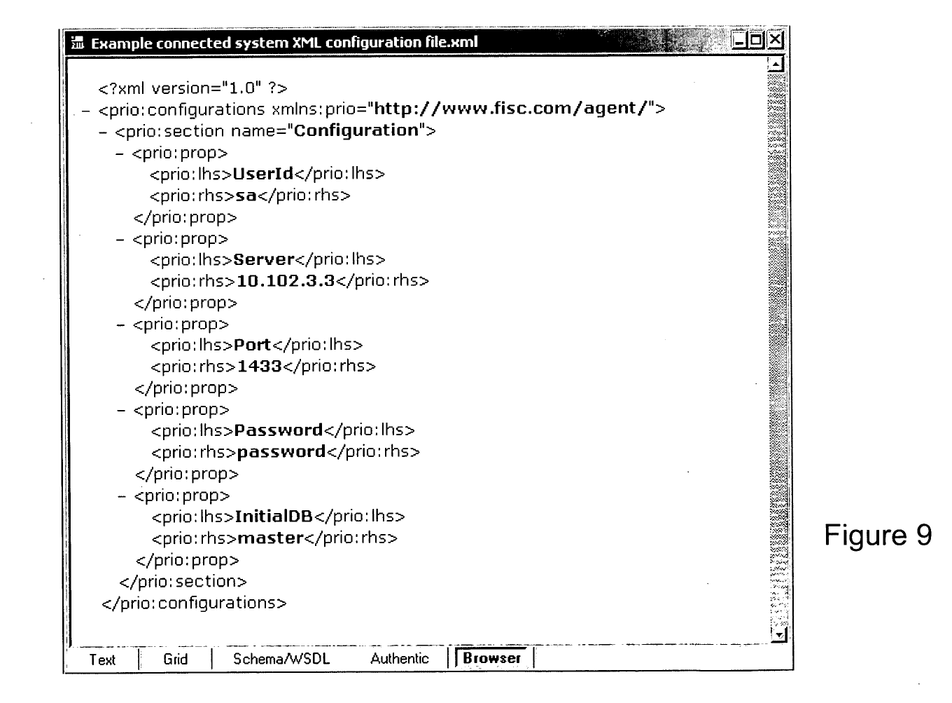

The Workflow Tool issues a “refresh schema” request to DataForum™, over the web services link (L1). DataForum™ issues a web services call over the secure connection (L4) to the remotely deployed Connectivity Component running at Company-B. An illustrative refresh schema request is shown in FIG. 10. The DataForum™ Connectivity Component (representing Company-B's LDAP directory service), binds to Company-B's LDAP directory service requesting its schema. The response (the current schema) is returned back over the secure link (L4) to DataForum™, at Company-A, and then streamed back to the Workflow Tool (L1). This is done for each connected system required as either a source or target for any new workflow provisioning process being configured.

This illustrative feature contributes to the elimination of scripting and programming typically found in competitive products. It also avoids errors in defining connected system schema and enables a rapid deployment process, and a reliable methodology for maintaining or extending IDM provisioning solutions to Cross Domain partners.

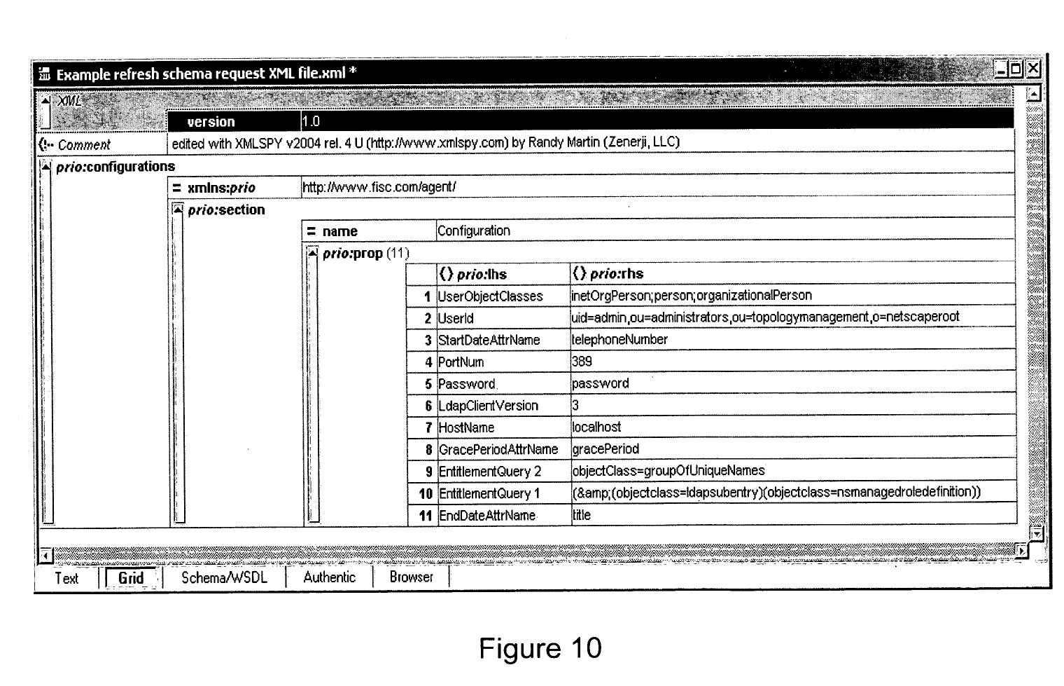

An illustrative Refresh Schema Response (partial response as the entire response may be over a thousand lines) is shown in FIG. 11. The response is parsed by the Workflow Tool and contains attributes used in the workflow attribute selection process shown in FIG. 3.

Design-Time Step 3—Attribute Selection, Attribute Mapping, Transformation Services

FIG. 3 is one example of a set of UIs, in the Workflow Tool, that permit the selection of a subset of connected system attributes required for a provisioning process. There can be thousands of attributes in a connected system schema. Our Workflow Tool provides a way of selecting only those required by a given workflow process, eliminating the need to deal with the hundreds, or thousands of attributes not required for a given workflow. The schema response is parsed and FIG. 3 is an example UI of a parsed schema refresh from a connected system.

Once the required attributes for source connected systems, and target connected systems have been selected, we're ready for the attribute mapping process. FIG. 4 is an example UI of the attribute mapping process. The “Fundamental Operation—Design-Time” (above) provides an overview of this process. FIG. 4 is a UI from our Workflow Tool which permits the mapping of source system attributes to target system attributes, as well as the selection of transformation services, database queries for additional information, the joining of existing event data with information returned from queries, and the use of over 50+ transformation rules in this example. This capability also helps us eliminate the need for programming, or scripting related to attribute mapping, and transformation services.

Design-Time Step 4—Workflow Deployment

Once connection points have been configured, attribute selection and mapping complete, its time to “Deploy” the workflow job. “Deploy” is a DataForum™ Design-Time service. The Workflow Tool executes a “Deploy” operation over the secure web services connection (L1), to the DataForum™ server (FIG. 8). The workflow job configuration is streamed to the DataForum™ server where DataForum™ stores a copy for Run-Time execution, and updates the DataForum™ LDAP server with pointers to the workflow run time files. FIG. 1 above shows DataForum™'s LDAP service where operational controls are stored and maintained. When an IDM trigger fires, DataForum™ will use the LDAP service to locate the appropriate workflow to process the trigger event.

The following parameters are passed from the Workflow Design Tool to the DataForum™ engine as part of the “Deploy Workflow” request:
1. Authentication token
2. Workflow ID
3. The workflow XML configuration file

In the example workflow configuration file below, there are four main sections. A workflow job section and three workflow task sections. The workflow job section <prio:job name=contains the workflow name and the operational parameters associated with running any DataForum™ workflow. In this example workflow, the three tasks consist of an RDBMS export, a mapping task, and an import task.

The 1^{st} workflow task <prio:task name=“To_DataHub_1” is the export configuration, or the configuration for receiving data from a DataForum™ trigger to the DataForum™ DataHub. The DataForum™ DataHub concept was reviewed in the “Fundamental Operational—Run-Time” above. The <prio:inifile statement following <prio:task name=“To_DataHub_1” is the configuration file for this 1^{st} workflow task.

The 2^{nd} workflow task, <prio:task name=“Join1” is the workflow mapping task. Following it is a long list of the mapping rules that were configured using the UI shown in FIG. 4 above.

The last task, <prio:task name=“To_Local SunOne_1” begins the configuration of the export task to update a target LDAP compliant directory service. The following prio:inifile is the configuration describing the attributes used for the update.

The example workflow XML file follows:

<Jobs xmins:prio=“http://www.fisc.com/prio/job”>
<prio:job name=“Create user account in LDAP” dispname=“Create user

account in LDAP” desc=“” dispdesc=“”createdBy=“admin”
createdDate=“1143662717332” deployedBy=“admin”
BusinessName=“Prio Directory Web” ServiceKey=“null” URLType=“http:”
URLName=“http://” servicecategory=“DefaultCategory”
bindingTemplateDesc=“”tModelInstanceInfoDesc=“' instanceParmsValue=“”
overviewDocDesc=“” overviewURL=“” syncwkflow=“0” workflowtype=“0”
enabled=“0” ExecMode=“1” Transient=“0” lastStarted=“0” lastEnded=“0” />

<prio:task name=“To_DataHub_1” desc=“” dependence=“none” schedules=“”

transdependence=“none” timeouttaskname=“null” timeoutvalue=“null”
IsHTTPDataSource=“0” CommandLine=“” ConnectedSystemName=“”
stagename=“DataHub” enabled=“1” completed=“0” laststarted=“0”
lastended=“0” IsQueueingEnabled=“0” IsDatedTransEnabled=“-1”
signing=“0” encryption=“0” agenttype=“DATAHUB” export=“0”
datatransfer=“1”>

<prio:source datafile=“To_DataHub_1.dat” />
<prio:inifile> <?xml version=“1.0”?> <prio:configurations

xmlns:prio=“http://www.fisc.com/agent/”> <prio:section
name=“XML”> </prio:section> <prio:section name=“General”>
</prio:section> </prio:configurations> </prio:inifile>
</prio:task>

<prio:task name=“Join1” desc=“” dependence=“To_DataHub_1”

schedules=“” transdependence=“none” timeouttaskname=“null”
timeoutvalue=“null” IsHTTPDataSource=“0” CommandLine=“” enabled=“1”
completed=“0” laststarted=“0” lastended=“0” IsQueueingEnabled=“0”
IsDatedTransEnabled=“-1” signing=“0” encryption=“0”
agenttype=“DataMapper” outputconverter=“LDIFXML” importdn=“”
datatransfer=“1”>

<prio:source inputtaskname=“To_DataHub_1” inputconverter=“XML”

exportdn=“” datafile=“To_DataHub_1.dat”/>

<prio:join> <?xml version=“1.0”?> <prio:rules
xmlns:prio=“http://www.fisc.com/prio”> <prio:section
record=“Profile” desc=“”> <prio:line enabled=“true”>
<prio:lhs>$baseDN</prio:lhs> <prio:op>Equals</prio:op>
<prio:rhs>&quot;ou=TestOU,dc=fisc,dc=int&quot;</prio:rhs>
<prio:comments>Comments</prio:comments> </prio:line>
<prio:line enabled=“true”> <prio:lhs>cn</prio:lhs>
<prio:op>Equals</prio:op>
<prio:rhs>USER_TABLE.FIRST_NAME</prio:rhs>
<prio:comments>Comments</prio:comments> </prio:line>
<prio:line enabled=“true”> <prio:lhs>sn</prio:lhs>
<prio:op>Equals</prio:op>
<prio:rhs>USER_TABLE.LAST_NAME</prio:rhs>
<prio:comments>Comments</prio:comments> </prio:line>
<prio:line enabled=“true”> <prio:lhs>initials</prio:lhs>
<prio:op>Equals</prio:op>
<prio:rhs>USER_TABLE.MIDDLE_NAME</prio:rhs>
<prio:comments>Comments</prio:comments> </prio:line>
<prio:line enabled=“true”> <prio:lhs>postalAddress</prio:lhs>
<prio:op>Equals</prio:op>
<prio:rhs>USER_TABLE.POSTAL_ADDRESS1</prio:rhs>
<prio:comments>Comments</prio:comments> </prio:line>
<prio:line enabled=“true”> <prio:lhs>telephoneNumber</prio:lhs>
<prio:op>Equals</prio:op>
<prio:rhs>USER_TABLE.TELEPHONE</prio:rhs>
<prio:comments>Comments</prio:comments> </prio:line>
<prio:line enabled=“true”> <prio:lhs>dn</prio:lhs>
<prio:op>Concat Value</prio:op>
<prio:rhs>&quot;cn=&quot;+USER_TABLE.FIRST_NAME+&quot;
&quot;+USER_TABLE.LAST_NAME+$baseDN</prio:rhs>
<prio:comments>Comments</prio:comments> </prio:line>
<prio:line enabled=“true”> <prio:lhs>objectClass</prio:lhs>
<prio:op>Equals</prio:op> <prio:rhs>&quot;top&quot;</prio:rhs>
<prio:comments>Comments</prio:comments> </prio:line>
<prio:line enabled=“true”> <prio:lhs>objectClass</prio:lhs>
<prio:op>Add to Value</prio:op>
<prio:rhs>&quot;person&quot; </prio:rhs>
<prio:comments>Comments</prio:comments> </prio:line>
<prio:line enabled=“true”> <prio:lhs>objectClass</prio:lhs>
<prio:op>Add to Value</prio:op>
<prio:rhs>&quot;organizationalPerson&quot;</prio:rhs>
<prio:comments>Comments</prio:comments> </prio:line>
<prio:line enabled=“true”> <prio:lhs>objectClass</prio:lhs>
<prio:op>Add to Value</prio:op>
<prio:rhs>&quot;inetOrgPerson&quot;</prio:rhs>
<prio:comments>Comments</prio:comments> </prio:line>
</prio:section> <prio:vars> <prio:var>$baseDN</prio:var>
<prio:var>$changetype</prio:var>
<prio:var>$defaultMapping</prio:var> <prio:var>$Exclude
Entry</prio:var> <prio:var>$modifytype</prio:var>
<prio:var>$recordIndex</prio:var>
<prio:var>$retainAttrs</prio:var> </prio:vars>
<SourceConnSysName></SourceConnSysName>
<TargetConnSysName>Local SunOne</TargetConnSysName>
<prio:outputdtd> <![CDATA[<!ELEMENT root (entry*)> <!ELEMENT
entitlement (#PCDATA)> <!ATTLIST root sessionid CDATA
#REQUIRED> <!ATTLIST entry changetype CDATA #REQUIRED>
<!ATTLIST entry modifytype CDATA #REQUIRED> <!ELEMENT entry
(entitlement*,cn*,dn*,givenName*,initials*,mail*,objectClass*,sn*,
telephoneNumber*,title*,postalAddress*)> <!ELEMENT cn
(#PCDATA)> <!ELEMENT dn (#PCDATA)> <!ELEMENT givenName
(#PCDATA)> <!ELEMENT initials (#PCDATA)> <!ELEMENT mail
(#PCDATA)> <!ELEMENT objectClass (#PCDATA)> <!ELEMENT sn
(#PCDATA)> <!ELEMENT telephoneNumber (#PCDATA)> <!ELEMENT
title (#PCDATA)> <!ELEMENT postalAddress (#PCDATA)>]]>
</prio:outputdtd> </prio:rules> </prio:join>
</prio:task>
<prio:task name=“To_Local SunOne_1” desc=“” dependence=“Join1”

schedules=“” transdependence=“none” timeouttaskname=“null”
timeoutvalue=“null” IsHTTPDataSource=“0” CommandLine=“”
ConnectedSystemName=“Local SunOne”
agentlocation =“http://localhost:8900/dataforum/servlet/SOAPServlet/
IPlanetWebService” enabled=“1” completed=“0” laststarted=“0”
lastended=“0” IsQueueingEnabled=“0” IsDatedTransEnabled=“-1”
signing=“0” encryption=“0” agenttype=“IPLANET” export=“0”
datatransfer=“1”>

<prio:source datafile=“Join1.dat” />
<prio:inifile> <?xml version=“1.0”?> <prio:configurations

xmlns:prio=“http://www.fisc.com/agent/”> <prio:section
name=“AgentAuditAttributes”> </prio:section> <prio:section
name=“AttributesForExport”> </prio:section> <prio:section
name=“Configuration”> <prio:prop systemProperty=“true”>
<prio:lhs>HostName</prio:lhs> <prio:rhs>localhost</prio:rhs>
</prio:prop> <prio:prop systemProperty=“true”>
<prio:lhs>PortNum</prio:lhs> <prio:rhs>389</prio:rhs>
</prio:prop> <prio:prop systemProperty=“true”>
<prio:lhs>UserId</prio:lhs> <prio:type>LdapDN</prio:type>
<prio:rhs>uid=admin,ou=administrators,ou=topologymanagement,o
=netscaperoot</prio:rhs> </prio:prop> <prio:prop
systemProperty=“true”> <prio:lhs>Password</prio:lhs>
<prio:rhs>admin</prio:rhs> </prio:prop> <prio:prop
systemProperty=“true”> <prio:lhs>LdapClientVersion</prio:lhs>
<prio:rhs>3</prio:rhs> <prio:values>2</prio:values>
<prio:values>3</prio:values> </prio:prop> <prio:prop
systemProperty=“true”> <prio:lhs>EntitlementQuery 1</prio:lhs>
<prio:rhs>(&amp;(objectclass=Idapsubentry)(objectclass=nsmanag
edroledefinition))</prio:rhs> </prio:prop> <prio:prop
systemProperty=“true”> <prio:lhs>EntitlementQuery 2</prio:lhs>
<prio:rhs>objectClass=groupOfUniqueNames</prio:rhs>
</prio:prop> <prio:prop systemProperty=“true”>
<prio:lhs>UserObjectClasses</prio:lhs>
<prio:rhs>inetOrgPerson;person;organizationalPerson</prio:rhs>
</prio:prop> <prio:prop systemProperty=“true”>
<prio:lhs>StartDateAttrName</prio:lhs>
<prio:rhs>startDate</prio:rhs> </prio:prop> <prio:prop
systemProperty=“true”> <prio:lhs>EndDateAttrName</prio:lhs>
<prio:rhs>endDate</prio:rhs> </prio:prop> <prio:prop
systemProperty=“true”>
<prio:lhs>GracePeriodAttrName</prio:lhs>
<prio:rhs>gracePeriod</prio:rhs> </prio:prop> <prio:prop>
<prio:lhs>DataFormat</prio:lhs> <prio:rhs>Profiles</prio:rhs>
<prio:values>Profiles</prio:values> </prio:prop> <prio:prop>
<prio:lhs>MaxConnections</prio:lhs> <prio:rhs> </prio:rhs>
</prio:prop> <prio:prop> <prio:lhs>SessionID</prio:lhs>
<prio:rhs>-1</prio:rhs> </prio:prop> <prio:prop>
<prio:lhs>SessionTimeout</prio:lhs> <prio:rhs> </prio:rhs>
</prio:prop> <prio:prop> <prio:lhs>SessionDisconnect</prio:lhs>
<prio:rhs>TRUE</prio:rhs> <prio:values>TRUE</prio:values>
<prio:values>FALSE</prio:values> </prio:prop> <prio:prop>
<prio:lhs>ModifyIfEntryExists</prio:lhs>
<prio:type>Import</prio:type> <prio:rhs>FALSE</prio:rhs>
<prio:values>TRUE</prio:values>
<prio:values>FALSE</prio:values> </prio:prop> <prio:prop>
<prio:lhs>AddIfEntryNotExists</prio:lhs>
<prio:type>Import</prio:type> <prio:rhs>FALSE</prio:rhs>
<prio:values>TRUE</prio:values>
<prio:values>FALSE</prio:values> </prio:prop> <prio:prop>
<prio:lhs>ImportDN</prio:lhs>
<prio:type>Import;LdapDN</prio:type> <prio:rhs>ou=Imported
Users,o=PQR,c=US</prio:rhs> </prio:prop> <prio:prop>
<prio:lhs>RDN</prio:lhs> <prio:type>Import</prio:type>
<prio:rhs>cn</prio:rhs> </prio:prop> <prio:prop>
<prio:lhs>UseLdapServerPaging</prio:lhs>
<prio:type>Export</prio:type> <prio:rhs>FALSE</prio:rhs>
<prio:values>TRUE</prio:values>
<prio:values>FALSE</prio:values> </prio:prop> <prio:prop>
<prio:lhs>ExportMode</prio:lhs> <prio:type>Export</prio:type>
<prio:rhs>FullExport</prio:rhs>
<prio:values>FullExport</prio:values>
<prio:values>DeltaExport</prio:values> </prio:prop> <prio:prop>
<prio:lhs>DeltaExportMode</prio:lhs>
<prio:type>Export</ prio type>
<prio:rhs>ChangedAndMandatoryAttributes</prio:rhs>
<prio:values>OnlyChangedAttributes</prio:values>
<prio:values>ChangedAndMandatoryAttributes</prio:values>
<prio:values>AllAttributes</prio:values> </prio:prop> <prio:prop>
<prio:lhs>ExportDN</prio:lhs>
<prio:type>Export;LdapDN</prio:type>
<prio:rhs>dc=fisc,dc=com</prio:rhs> </prio:prop> <prio:prop>
<prio:lhs>SortKey</prio:lhs> <prio:type>Export</prio:type>
<prio:rhs> </prio;rhs> </prio:prop> <prio:prop>
<prio:lhs>Filter</prio:lhs>
<prio:type>Export;LdapFilter</prio:type>
<prio:rhs>objectclass=person</prio:rhs> </prio:prop> <prio:prop>
<prio:lhs>Scope</prio:lhs> <prio:type>Export</prio:type>
<prio:rhs>AllLevels</prio:rhs>
<prio:values>AllLevels</prio:values>
<prio:values>OnlyDN</prio:values>
<prio:values>OneLevel</prio:values> </prio:prop> <prio:prop>
<prio:lhs>MaxResults</prio:lhs> <prio:type>Export</prio:type>
<prio:rhs>300</prio:rhs> </prio:prop> <prio:prop>
<prio:lhs>ResultsPerPage</prio:lhs>
<prio:type>Export</prio:type> <prio:rhs>20</prio:rhs>
</prio:prop> <prio:prop> <prio:lhs>PageIndex</prio:lhs>
<prio:type>Export</prio:type> <prio:rhs>-1</prio:rhs>
</prio:prop> <prio:prop> <prio:lhs>PageRefresh</prio:lhs>
<prio:type>Export</prio:type> <prio:rhs>FALSE</prio:rhs>
<prio:values>TRUE</prio:values>
<prio:values>FALSE</prio:values> </prio:prop> <prio:prop>
<prio:lhs>Id</prio:lhs> <prio:type>Import</prio:type>
<prio:rhs>dn</prio:rhs> </prio:prop> <prio:prop>
<prio:lhs>loginId</prio:lhs> <prio:type>Import</prio:type>
<prio:rhs>cn</prio:rhs> </prio:prop> <prio:prop>
<prio:lhs>ReadDN</prio:lhs>
<prio:type>Export;LdapDN</prio:type> <prio:rhs></prio:rhs>
</prio:prop> <prio:prop> <prio:lhs>Export</prio:lhs>
<prio:rhs>FALSE</prio:rhs> </prio:prop> <prio:prop>
<prio:lhs>Import</prio:lhs> <prio:rhs>TRUE</prio:rhs>
</prio:prop> <prio:prop> <prio:lhs>TaskName</prio:lhs>
<prio:rhs>To_Local SunOne_1</prio:rhs> </prio:prop> <prio:prop>
<prio:lhs>KeyValueAttribute</prio:lhs> <prio:rhs></prio:rhs>
</prio:prop> <prio:prop> <prio:lhs>RoleIDAttribute</prio:lhs>
<prio:rhs> </prio:rhs> </prio:prop> <prio:prop>
<prio:lhs>EnableTaskAudit</prio:lhs> <prio:rhs>TRUE</prio:rhs>
<prio:values>TRUE</prio:values>
<prio:values>FALSE</prio:values> </prio:prop> </prio:section>
<prio:section name=“AttributesForlmport”> <prio:prop>
<prio:lhs>AttrNameForImport</prio:Ihs>
<prio:rhs>postalAddress</prio:rhs> </prio:prop> <prio:prop>
<prio:lhs>AttrNameForImport</prio:lhs>
<prio:rhs>title</prio:rhs> </prio:prop> <prio:prop>
<prio:lhs>AttrNameForImport</prio:lhs>
<prio:rhs>telephoneNumber</prio:rhs> </prio:prop> <prio:prop>
<prio:lhs>AttrNameForImport</prio:lhs> <prio:rhs>sn</prio:rhs>
</prio:prop> <prio:prop> <prio:lhs>AttrNameForImport</prio:lhs>
<prio:rhs>objectClass</prio:rhs> </prio:prop> <prio:prop>
<prio:lhs>AttrNameForImport</prio:lhs>
<prio:rhs>mail</prio:rhs> </prio:prop> <prio:prop>
<prio:lhs>AttrNameForImport</prio:lhs>
<prio:rhs>initials</prio:rhs> </prio:prop> <prio:prop>
<prio:lhs>AttrNameForImport</prio:lhs>
<prio:rhs>givenName</prio:rhs> </prio:prop> <prio:prop>
<prio:lhs>AttrNameForImport</prio:lhs> <prio:rhs>dn</prio:rhs>
</prio:prop> <prio:prop> <prio:lhs>AttrNameForImport</prio:Ihs>
<prio:rhs>cn</prio:rhs> </prio:prop> </prio:section>
</prio:configurations> </prio:inifile>
</prio:task>
</Jobs>

Design-Time Step 5—Workflow Trigger Configuration

In this example workflow, we have a source RDBMS system in domain-1, and a target LDAP system in domain-2. When certain changes occur in the source RDBMS system, we want a database trigger to run. After “Deploying” the workflow, the next step is to configure the database trigger. The Workflow Tool is used to configure and “Deploy” an RDBMS trigger. The trigger can't be configured until after the associated workflow has been deployed as the trigger configuration must reference the associated workflow. Trigger configuration parameters include:

Associated workflow name

RDBMS table and event information (add, modify, delete)

DataForum™ Web Services connection information

Attributes that flow as part of the trigger

After configuring the trigger, the trigger is “Deployed” to the DataForum™ server which in turn issues an RDBMS service call to deploy the trigger (L6). A trigger handler and the associated trigger configuration files are stored on the RDBMS platform ready to execute RDBMS events.

The following parameters are passed from the Workflow Tool to the DataForum™ engine as part of the “Deploy Trigger” operation:
1. Authentication token
2. Trigger ID
3. Trigger configuration XML file

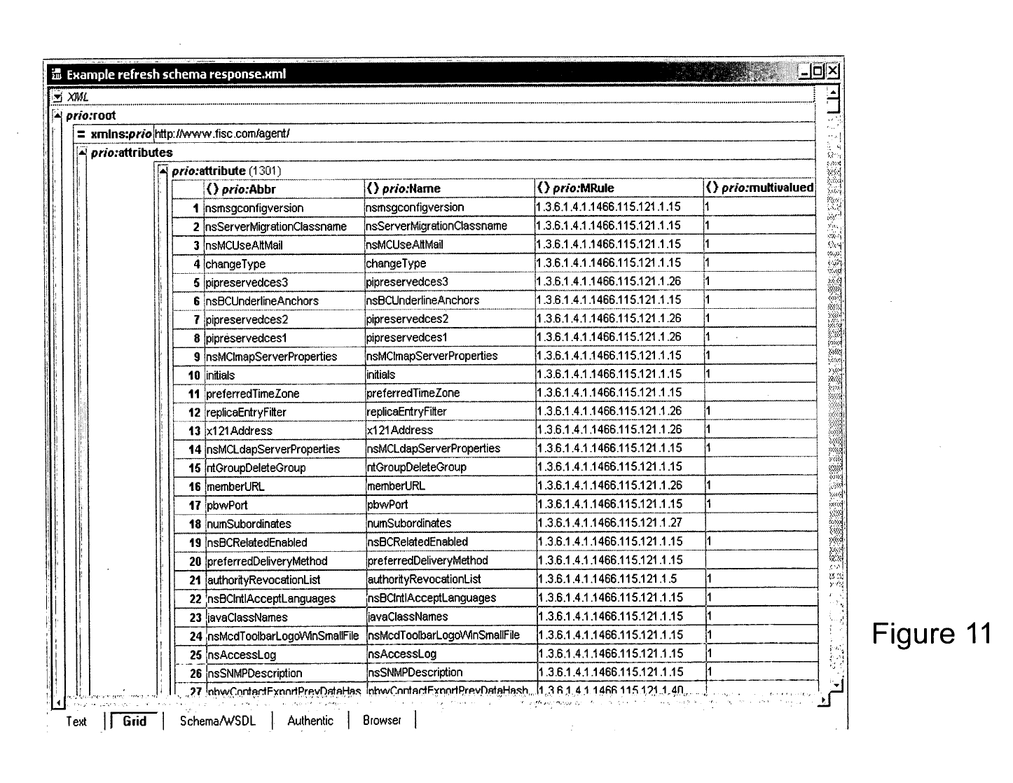

FIG. 12 shows an exemplary trigger configuration file. This trigger confirmation file has two main sections, a trigger job section and a trigger task section. The statement <prio:job name=“Test MSSQL Trigger” is the beginning of the trigger job section containing DataForum™ operational trigger controls. The <prio:task name=“To_Trigger_1” contains the trigger configuration and the <prio:inifile contains the associated configuration for the attributes that will flow with the trigger event.

Once the trigger is deployed, RDBMS events may cause the trigger to fire and execute DataForum™ workflows. See the “Cross Domain Provisioning—Run-Time Example Flow” section below.

Cross Domain Provisioning—Run-Time Example Flow

We mentioned earlier that Company-B was providing a service to Company-A, the service needs to be requested and the employee must be provisioned to Company-B's LDAP service in order to use the service. We can assume the request for service causes a record to be added to a table in Company-A's RDBMS. Considering we've deployed an RDBMS trigger to listen for the events that represent Company-B service requests, our trigger handler will execute each time one of these events occurs.

Run-Time Step 1—RDBMS Trigger Event Fires

A Company-A employee causes a request for service to be added to Company-A's RDBMS system. The deployed DataForum™ trigger is launched on Company-A's RDBMS platform to execute the RDBMS event handler. The deployed RDBMS handler establishes a web service connection (L6, SOAP) to the DataForum™ server. The trigger handler uses the trigger configuration file described at Design-Time, to determine which attributes must flow with the trigger event. The trigger handler streams the event and all associated data to the DataForum™ server.

The following parameters are sent to the DataForum™ server:
1. TriggerID-eg:66756667
2. RDBMS data XML associated with the event

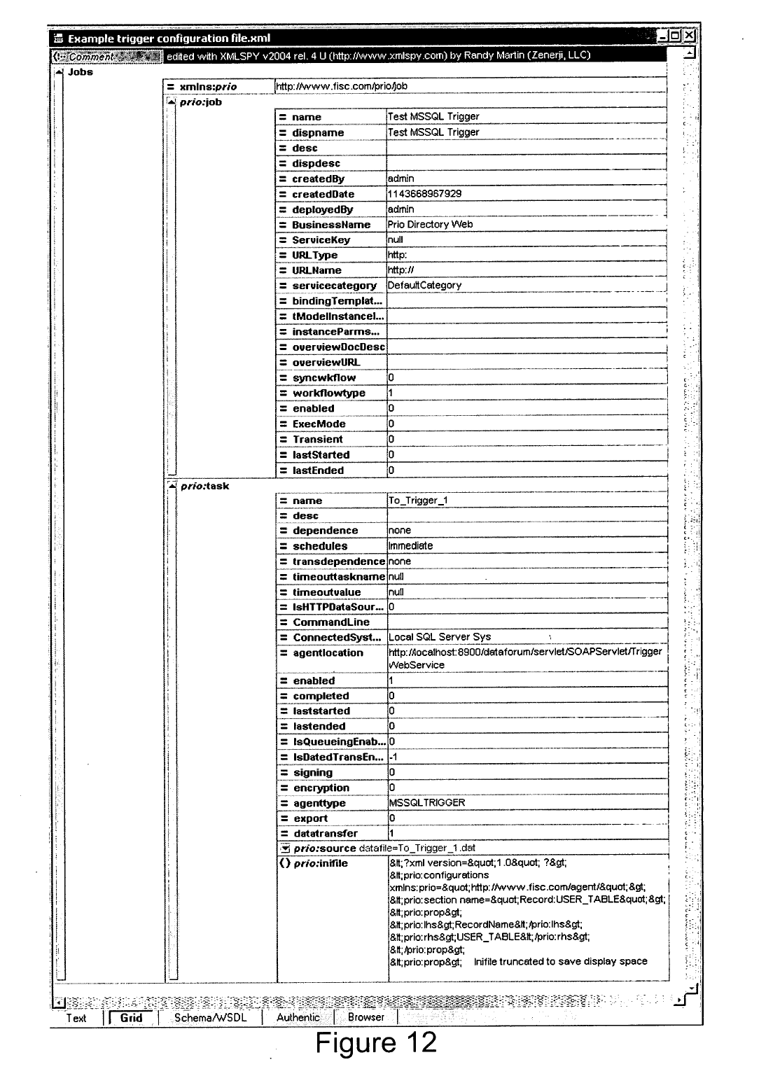

FIG. 13 shows exemplary RDBMS event trigger information. The trigger handler uses the XML configuration file described by Design-Time Step-5 above. In the example in FIG. 13, the <jdbc:record changetype=“add” represent the new entry and has only a few attributes associated with it. If need be the entire new RDBMS table record can flow, or a portion of the record, or the DataForum™ workflow could have been configured to query additional information for processing by the DataForum™ workflow.

Run-Time Step 2—Schedule DataForum™ Workflow Execution

The trigger ID has an associated workflow ID that was deployed during Design-Time. Using the DataForum™ LDAP directory service, DataForum™ determines which workflow to execute, locates the associated configuration file that was created during Design-Time “Deploy Workflow”, and begins processing workflow task 1.

Run-Time Step 3—DataForum™ Workflow Execution—Task 1

In our example, task 1 is a task to populate the DataForum™ DataHub. Workflow task 1 uses <prio:task name=“To_DataHub_1” of the XML configuration file described by Design-Time Step-4. Attribute information from the trigger handler is used to populate the DataHub XML schema.

Run-Time Step 4—DataForum™ Workflow Execution—Task 2

The 2^{nd} workflow task is the mapping task. The mapping task uses <prio:task name=“Join1” portion of the XML configuration file described by Design-Time Step 4. This portion of that XML configuration file contains quite a few mapping rules in XML format. FIG. 4 is the Workflow Tool UI that was used to configure mapping rules. Each line in FIG. 4 represents an XML statement in the <prio:task name=Join1 set of XML statements. Each line represented by FIG. 4 is executed in sequence one line at a time. If-Then-Else kinds of configurations can be used to conditionally skip lines. Each line might consist of a source attribute, from our Design-Time source system “Schema Refresh” operation, possibly a target attribute, from our target system “Schema Refresh” operation, as well as a transformation rule used to determine how the information will be processed.

Run-Time Step 5—DataForum™ Workflow Execution—Task 3

The 3^{rd} task in our example workflow is the target system export task. DataForum™ is running in Domain-1 (Company-A) and this task must export the result of workflow task 2 (mapping), to the LDAP directory service running in Domain-2 (Company-B).

During the execution of task 3, through the use of the DataForum™ Connectivity Component Architecture, DataForum™ establishes a web services connection (L4, FIG. 8) to the Connectivity Component running in Domain-2 (Company-B). The connection is secured and both ends authenticated using digital certificates. An import request is streamed from DataForum™ to the Connectivity Component. (An export from the DataHub becomes an import to the target.) The connectivity component binds to the associated LDAP directory service (L5) running at Company-B.

The following parameters were used with the Import request:
1. Authentication token
2. Job Instance ID
3. Task instance ID
4. Workflow ID
5. TaskName
6. AuditInfo structure
7. Data xml file containing the import data

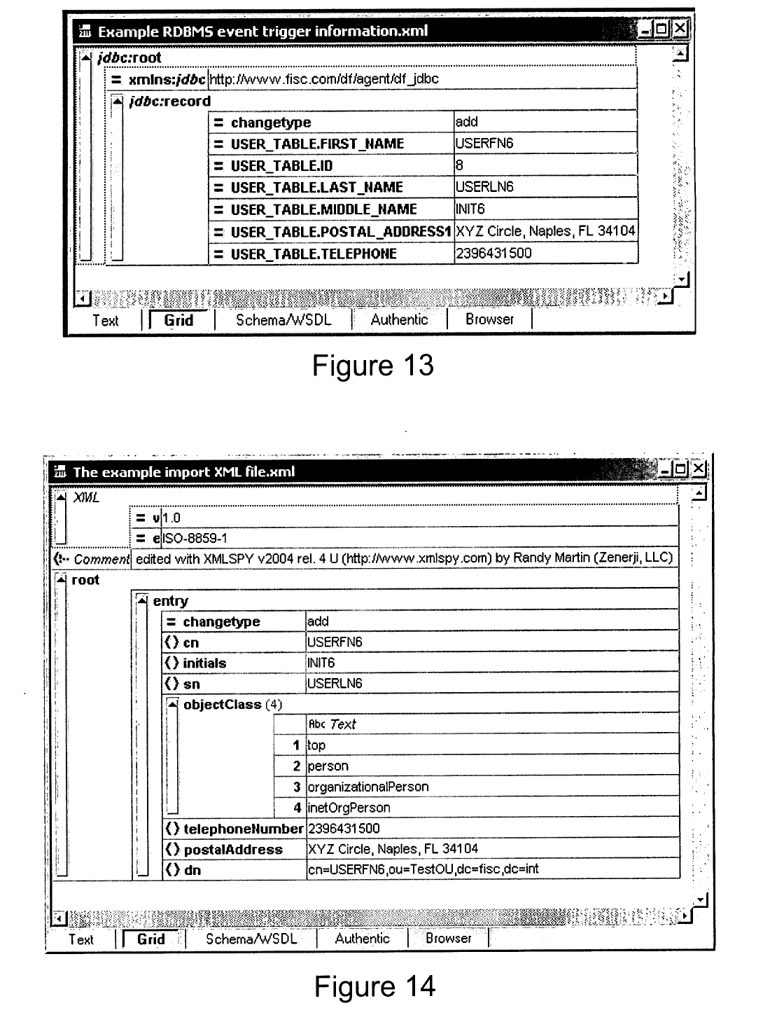

FIG. 14 shows an exemplary Import XML stream. The example Import XML stream shows the minimal requirement in this illustrative implementation for a changetype=“add”, for the inetOrgPerson object class, as well as a couple of attributes like the telephone number and the address.

The specific arrangements and methods described herein are merely illustrative of the principles of the illustrative implementations. Numerous modifications in form and detail may be made by those of ordinary skill in the art without departing from the scope of the present invention. Although the invention has been shown in relation to a particular embodiment, it should not be considered to be limited. rather the present invention is limited only by the scope of the appended claims.

1. In a computer system having a plurality of computers coupled to a channel over which computers may exchange messages, a method of creating a resource management workflow comprising:
creating at least one resource provisioning workflow task including identifying a source computer in a first company for obtaining provisioning data and a target computer in a second company for receiving provisioning data;
defining at least one mapping rule for transforming data from said at least one source computer in said first company into data appropriate for said target computer in said second company;
configuring a response to at least one trigger event such that the trigger event will cause said provisioning workflow task to be executed; and
installing at least one trigger event such that such that the trigger event is associated with said at least one source computer in said first company such that when such trigger event occurs on said source computer in said first company said at least one provisioning workflow task will be executed.

2. A method according to claim 1 wherein said creating at least one provisioning workflow task includes:
retrieving from a central source a list of computer systems configured to work with said provisioning system;
selecting at least one of said computer systems to be a source computer for provisioning data; and
selecting one of said computer systems to be a target computer for provisioning data;

3. A method according to claim 1, wherein said step of defining at least one mapping rule includes:
selecting at least one source data field from a schema associated with said at least one source computer to be used as the source of data to be transformed;
selecting a target data field from a schema associated with said target computer as the destination of the transformed data;
selecting one or more transformation method from a list of predefined methods to transform data from said at least one source data field into data appropriate for said target data field.

4. A method according to claim 1 wherein the step of creating at least one provisioning workflow task includes the step of causing a schema associated with the at least said source computer or said target computer to be retrieved from at least said source computer or said target computer respectively;

5. A method according to claim 1 wherein the creating step includes using a graphical user interface enabling the selecting of data fields and mapping methods from lists of compatible choices, thus enabling a user to create said provisioning workflow task.

6. A method according to claim 1 wherein said creating step includes the step of defining cryptographic methods for protecting the confidentiality and integrity of data being transferred.

7. A method according to claim 6 wherein said cryptographic methods include the use of WS-Secure methodology.

8. A method according to claim 6 wherein said cryptographic methods include the use of Public Key Infrastructure methodology.

9. A method according to claim 1 wherein said creating step includes defining an audit trail entry that is generated whenever said workflow task is executed.

10. In a computer system having a plurality of computers coupled to a channel over which computers may exchange messages, a method of resource provisioning comprising:
activating a trigger event handler associated with a source computer in a first company in response to the occurrence of an associated trigger event and collecting data associated with said trigger event;
providing said data and a notification of the triggering event to a provisioning system; and
initiating by said provisioning system at least one provisioning workflow task associated with said event to collect source data from at least one source computer in said first company, perform at least one mapping transformation on said source data to produce target data, and provide said target data to a target computer in said second company.

11. A method according to claim 10, further including providing event detail data to an audit trail component.

12. A method according to claim 10, wherein the provisioning workflow task includes the step of establishing a secure communications link between the source computer or the target computer or both and the provisioning system.

13. A method according to claim 12, wherein the secure communications link protects the confidentiality of the communication.

14. A method according to claim 12, wherein the secure communications link protects the integrity of the communication.

15. A method according to claim 12, wherein the secure communications link is based upon WS-Secure technology.

16. A method according to claim 12, wherein the secure communications link is based upon web service technology.

17. A method according to claim 12, wherein the secure communications link uses Public Key Infrastructure technology.

18. A method according to claim 10 wherein said provisioning workflow task executes in substantially real time as a result of the triggering event.

19. A method according to claim 10 wherein said provisioning workflow executes at a scheduled time as the result of the triggering event.

20. In a computer system having a plurality of computers coupled to a channel over which computers may exchange messages, a method of creating a cross organizational user identity provisioning workflow comprising:
creating at least one identity provisioning workflow task including identifying a source computer in a first organization for obtaining identity provisioning data and a target computer in a second organization for receiving identity provisioning data;
defining at least one mapping rule for transforming data from said at least one source computer in said first organization to data appropriate for said target computer in said second organization as the result of a change in status of an individual;
configuring a response to at least one trigger event such that the triggering event will cause said identity provisioning workflow task to be executed; and
installing said at least one trigger event such that it is associated with said at least one source computer in said first organization such that when said trigger event occurs on said source computer said at least one identity provisioning workflow task will be executed.

21. A method according to claim 20, wherein said step of creating at least one identity workflow provisioning task includes:
retrieving from a central source a list of computer systems configured to work with said identity provisioning system;
selecting at least one of said computer systems in one organization to be a source computer for provisioning data; and
selecting one of said computer systems in a second organization to be a target computer for provisioning data.

22. A method according to claim 20 wherein said trigger event corresponds to an employee joining an organization.

23. A method according to claim 20, wherein said trigger event corresponds to an employee leaving an organization.

24. A method according to claim 20 wherein said trigger event corresponds to an employee changing his assigned responsibilities.

25. A method according to claim 20, wherein a resource being provisioned corresponds to a service provided to an organization by a third party organization and the target computer is controlled by the third party organization.

26. A method according to claim 20, where said step of defining at least one mapping rule includes:
selecting at least one source data field from a schema associated with said at least one source computer to be used as the source of data to be transformed;
selecting a target data field from a schema associated with said target computer as the destination of the transformed data; and
selecting one or more transformation methods from a list of predefined methods to transform data from said at least one source data field into data appropriate for said target data field.

27. A method according to claim 20 wherein said first organization provides provisioning services to said second organization using the Software as a Service (SaaS) methodology.
